(19) United States
(12) Patent Application Publication
(10) Pub. No.: US 2004/0125143 A1
(43) Pub. Date: Jul. 1, 2004

(54) Display system and method for displaying a multi-dimensional file visualizer and chooser

(76) Inventors: Kenneth Deaton, Toronto (CA); Phil Lysons, Brampton (CA); Steven A. Gedeon, Toronto (CA)

Correspondence Address: GREGORY SMITH & ASSOCIATES, 3900 NEWPARK MALL ROAD, 3RD FLOOR, NEWARK, CA, 94560, US

(21) Appl. No.: 10/625,836

(22) Filed: Mar. 22, 2003

Related U.S. Application Data
(60) Provisional application No. 60/398,054, filed on Jul. 22, 2002.

(51) Int. Cl. G09G 5/00

(52) U.S. Cl. 345/765

(57) ABSTRACT

A multi-dimensional file visualizer and chooser allows the user to rapidly and effectively view and select their files. The visualizer and chooser is a computer software application that structures different file types and applies 3D GUI visualization technology to allow users an improved ability to visualize and select the file they are interested in. The specific application provides the ability to maintain context among file sources as well as focus on the specific files being examined and/or selected.

### CROSS REFERENCE TO OTHER APPLICATIONS

This application claims the benefit of U.S. Provisional Application No. 60/398,054. filed Jul. 22, 2002, which is hereby incorporated by reference in its entirety.

### FIELD OF THE INVENTION

The present invention relates generally to the application of 3D to computer file structures, file visualization, and Graphical User Interfaces (3D GUI). More specifically, the invention relates to adding further information and/or personalization to the attributes of a file on a personal computer. The visualizer and chooser may also be used with game consoles, set-top computing platforms, mobile devices, and other computing platforms.

### BACKGROUND OF THE INVENTION

As our file storage capacity grows and the number of files, images, songs, e-mails, websites, documents, folders, and bookmarks increases, we must be able to quickly find the right file —the proverbial needle in a haystack.

3D file visualization is a set of sophisticated techniques that has a variety of uses, including website management, business intelligence, hierarchical file directories and other areas where large sets of complex files need to be managed. Interactive 3D graphics provide a powerful navigation tool for analyzing and synthesizing vast amounts of information. The present invention has been designed and developed with one goal: to allow users to better explore, understand and select from a large, complex number of files and amount of information.

A 3D graphical user interface suitable for use with the present invention is described in U.S. patent application Ser. No. 10/145,567, filed on May 13, 2002, for Method and system for automatically creating and displaying a customizable three-dimensional graphical user interface (3D GUI) for a computer system, and U.S. patent application Ser. No. 10/145,576, filed on May 13, 2002, for Method and system for creating and distributing collaborative multi-user three-dimensional websites for a computer system (3D Net Architecture). These and all other patents and patent applications referred to herein are hereby incorporated by reference in their entirety.

### US REFERENCES

U.S. Pat. No. 5,528,735 to Strasnick et al. entitled “Method and apparatus for displaying file within a three-dimensional information landscape” (June 1996).

U.S. Pat. No. 5,786,820 to Robertson entitled “Method and apparatus for increasing the displayed detail of a tree structure” (July 1998).

U.S. Pat. No. 5,880,733 to Horvitz et al. entitled “Display system and method for displaying windows of an operating system to provide a three-dimensional workspace for a computer system” (March 1999).

U.S. Pat. No. 5,956,038 to Rekimoto entitled “Three-dimensional virtual reality space sharing method and system, an information recording medium and method, an information transmission medium and method, an information processing method, a client terminal, and a shared server terminal” (Sept. 1999).

U.S. Pat. No. 6,085,256 to Kitano et al. entitled “Cyber space system for providing a virtual reality space formed of three dimensional pictures from a server to a user via a service provider” (July 2000).

U.S. Pat. No. 6,111,581 to Berry et al. entitled “Method and system for classifying user objects in a three-dimensional (3D) environment on a display in a computer system” (August 2000).

U.S. Pat. No. 6,121,971 to Berry et al. entitled “Method and system for providing visual hierarchy of task groups and related viewpoints of a tree dimensional environment in a display of a computer system” (September 2000).

U.S. Pat. No. 6,175,842 to Kirk et al. entitled “System and method for providing dynamic three-dimensional multi-user virtual spaces in synchrony with hypertext browsing” (January 2001).

U.S. Pat. No. 6,230,116 to Ronen et al. entitled “Apparatus and method for interacting with a simulated 3D interface to an operating system operative to control computer resources” (May 2001).

### SUMMARY OF THE INVENTION

The present invention takes the form of a multi-dimensional file visualizer and chooser that allows the user to rapidly and effectively view and select their files. The visualizer and chooser is a computer software application that structures different file types and applies 3D Graphical User Interface (3D GUI) visualization technology to allow users an improved ability to visualize and select the file they are interested in. The application provides the ability to maintain context among file sources as well as focus on the specific files being examined and/or selected.

The present invention includes a system for applying XML information to existing file sets, including an editor for establishing the number and type of XML file to be entered. The editor allows the user to automatically or manually input the XML tags. Once the XML tags are created the user can sort and view the underlying files based on application of rules or filters to the XML tags. The system may be used for many different situations, including visualization of MP3 files, search engine results, file visualizations, bookmarks, etc. The sorting and viewing may be accomplished in a standard 2D environment or in a specialized 3D environment. The files may also be displayed in clusters of associated files (in contrast to displaying hierarchical associations or folder-based hierarchies).

### BRIEF DESCRIPTION OF THE DRAWING

FIG. 1 is a flow chart of the present invention.

### DESCRIPTION OF THE INVENTION

A typical configuration for a personal computer system includes a processing unit, a display, a keyboard, and a mouse. The processing unit executes a computer program called the operating system (O/S) that allows the operation of the computer system to be controlled either directly by the user or by other computer programs called applications. A user operates the computer system by entering commands using the keyboard and mouse. In response, the processing unit executes the commands and presents feedback to the user via the display. The portion of the operating system that accepts the user commands and presents feedback to the user is called the user interface.

Various schemes for implementing the user interface are generally categorized by the manner in which the user interacts with the system. For example, in a typical command line user interface, such as DOS (by MICROSOFT), the user inputs text from a keyboard; in response, the computer system returns text messages to the display. However, in a Graphical User Interface (GUI), such as MICROSOFT WINDOWS, the user can interact with the computer system by manipulating graphical objects on the display screen using the keyboard and/or the mouse.

The typical 2D GUI is normally described as a desktop metaphor. The desktop is the background and superimposed onto the desktop are a number of icons and/or rectangular graphical objects called windows. Users can interact with the computer either by working within the window application (e.g. using a word processing application or drawing application inside the window) or by launching new applications by double-clicking on icons.

The typical way to navigate the user's directory is to give each file, image, application, or audio file a filename and then to sort through lists of names to select the file or application required (e.g. WINDOWS EXPLORER). The primary alternative to this sorting methodology is to also give each file, image or application an icon and place these icons within folders. The user can sort through folders and look at icons to find the file they want, and then click or double click on the icon to launch the file or application. A major problem with sorting by icons is that they all tend to look the same and are not content-representative of the underlying file (e.g. they all look like folders or all look like WORD document icons).

In contrast, in the present invention, a multi-dimensional file visualizer and chooser represents a dramatic departure from the traditional way for users to view and select files.

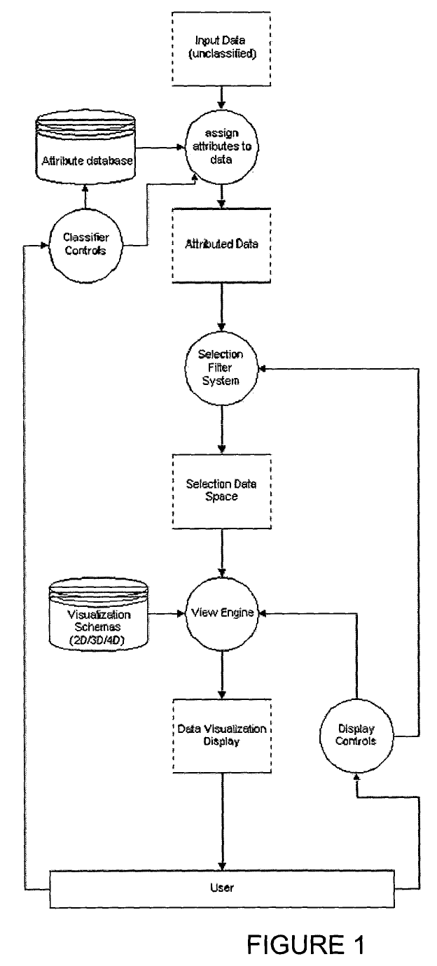

The file visualizer and chooser can best be thought of in reference to its 5 primary functions as shown in FIG. 1:

1) Assigning attributes to the file: In this step, the file is assigned attributes in addition to the traditional attributes in WINDOWS such as filename, file type (.doc, .xls . . . ), size, and date modified. Additional attributes can include client name, importance, key words, user name, ratings, classifications, and other information. These attributes and classifications can be assigned manually or automatically and are then stored in a database.

2) Creating a selection space or interface: In this step, the file visualizer and chooser will scan the user's files, folders, hard drives and other sources and create viewable images representing the file types in question (a preferred embodiment of these images will be content-representative images that can also be called WYSIWYG icons or What You See Is What You Get icons). The file visualizer and chooser then arranges these images and/or icons into a selection space or interface according to the criteria selected. For example, all of a user's images can be scanned and then arranged into a 2D grid or “checkerboard”.

3) Modifying or conformation of the selection space: In this step, the user can arrange the files within the selection space either manually or through automated tools using the display controls and the selection filter system. Conformation or arranging of the selection space by user parameters is a powerful tool to develop the context for each file type. For example, songs can be categorized by music type or artist or date. They can be arranged in a simple 2D grid, they can be arranged in a 3D grid cube (like a Rubik's cube) with all the songs by a given artist being arranged in the Z orientation, or they can be arranged in a realistic representation manner to look like CDs on a shelf in a home or library.

4) Viewing the files within the selection space: In its simplest form, the file visualizer and chooser viewer can act as a type of fisheye lens that is passed over the top of the selection space. The file(s) directly under the lens representation are magnified and brought forward for closer viewing. More powerful viewing formats include magnifying the nearest neighbors as well, and thus maintaining context within the selection space as well as the additional focus within the data visualization space. Additional elegant and/or playful viewing techniques include the file types “flying” into the visualization space and rearranging themselves as the “lens” is passed over the selection space.

5) Modifying the viewer: Instead of a simple fisheye lens, the file visualizer and chooser can scan using different scanning algorithms, such as “drilling” deeper into the 3D grid or by including different percentages of nearest neighbors, or by using other more sophisticated viewing algorithms to view multi-dimensional selection spaces. These visualization types or schemas are stored in a database and can be modified with the display controls to alter what the view engine does to create the file visualization display.

The files may be displayed in a representational schema, but there will be times when the underlying information or data is more conducive to abstract representation. Access to file directories, surf histories, bookmarks, e-mail, and Internet traffic is achieved in 3D space using alternative visualization strategies, referred to as schemas. Thus, hundreds of MP3 files can be represented as CDs stored on bookshelves in a virtual room (using a highly representational 3D schema) or they can be accessed via abstract hierarchical tree structures, cone trees, cityscapes, or other visualization schemas. The goal is to apply domain specific knowledge and use the best 3D GUI strategy for the given application and file type.

It is not uncommon to see people with hundreds of emails, bookmarks, or documents, or a music collection with thousands of songs from hundreds of albums sorted into dozens of folders. The same issues apply to businesses that manage extensive information resources and the field of knowledge management and business intelligence is rapidly expanding.

New ways of sorting and organizing are constantly required that go beyond what is currently possible using the standard MICROSOFT WINDOWS EXPLORER file management system. By going beyond the limited set of attributes available with contemporary operating systems such as WINDOWS, MAC OS and LINUX, the present invention adds the ability to associate additional attributes to file system entities. These attributes will be of the following general types:

a) user-created and assigned

b) 3rd party classification schemes (e.g. use the music classification system provided by the music publisher or your local radio station or the WYSIWYG icons can be arranged according to XML metatags)

c) automatically synthesized by analysis of the entity (a simple example would be finding the average color of an image, but other more complex analyses could also be performed to create figures, images, and/or sounds.)

These attributes are stored in a custom database mechanism (either on the local system or accessed via the Internet). This database is then capable of performing logical operations to select datasets for including in the selection space and viewing in a manner similar to the ANSI-standard Structured Query Language (SQL).

Another requirement of the database is the ability to distribute the file so that 3rd party classifications can be maintained in a central location accessible via the Internet. The invention also allows the user to store their personal schemas in an internet-accessible portal rather than tying it to a particular computer. This feature anticipates that this requirement is necessary to support mobile personal computing in the future.

The user can then run powerful searches to arrange sets of their appropriate files into a selection space. These selection spaces can then be saved in various schemas. For example, the user's music files can be saved as a music room with their music arranged alphabetically or by genre along with their associated media players, music websites, and fan club chat rooms. Alternatively, their music can be saved in an abstract representation where the most recently played music is brighter. . .

The WYSIWYG icons may be manually or automatically generated based on file-driven filtering factors, such as file size, date or times accessed, preferences, thereby creating an icon with features such as size, color, frequency of vibration, sound, etc. If the files are songs, the songs can be sorted by date, alphabetically, preference, etc. The file icon may be created with multiple icons combined together or by placing icons within icons. If desired, an auditory sonification may also be added to the file.

The present invention includes a system for applying XML information to existing file sets, including an editor for establishing the number and type of XML file to be entered. The editor allows the user to automatically or manually input the XML tags. The XML tags may be created using fuzzy logic to analyze imprecise terminology, such as degree of rock'n rolliness, degree of preference, slow or fast beat, etc.

Once the XML tags are created the user can sort and view the underlying files based on application of rules or filters to the XML tags. The system may be used for many different situations, including visualization of MP3 files, search engine results, file visualizations, bookmarks, etc. The sorting and viewing may be accomplished in a standard 2D environment or in a specialized 3D environment. Schemas for viewing the files include, but are not limited to a planetarium, a volumetric or hyperbolic shape, a landscape, a tree structure, a cityscape, a grid array, and a daterium. The files may also be displayed in clusters of associated files (in contrast to displaying hierarchical associations or folder-based hierarchies).

An example of one use of the present ivention is the ability to take a list of search engine results and display the resulting links in a 3D environment in order to increase the amount of information viewed and improve the ability to follow the best set of links. The user may also have the ability to have the edges between nodes reflect the preference state, or number of additional links, or number of pages linked to the node. The user may also have the ability for the node attributes to reflect additional information, such as the size of the node reflects the size of the website, the shape of the node reflects the type of website, the vibration of the node reflects the number of hits that site gets per month, etc.

The system may be set up to allow the user to rearrange the icons within the display. The system would then apply a reverse transformation and modify or create one or more XML tags so that a future application of the rules or filters will result in the user's rearrangement of the icons.

The system may be created as a platform independent display system and method for displaying a customizable graphical user interface. The system could be created to run on WINDOWS, MACINTOSH, LINUX, or other personal computing systems, workstations, servers and laptops. The system may also be used for many other electronic environments including game consoles, set-top boxes, personal computers, plant floor manufacturing equipment, automated control systems, mobile and wireless devices (but not including TV remote control devices).

The present invention may be used in may fields including, but not limited to business intelligence, knowledge management, scientific visualization, etc.

Many features have been listed with particular configurations, options, and embodiments. Any one or more of the features described may be added to or combined with any of the other embodiments or other standard devices to create alternate combinations and embodiments.

Although the examples given include many specificities, they are intended as illustrative of only a few possible embodiments of the invention. Other embodiments and modifications will, no doubt, occur to those skilled in the art. Thus, the examples given should only be interpreted as illustrations of some of the preferred embodiments of the invention, and the full scope of the invention should be determined by the appended claims and their legal equivalents.

What is claimed is:

1. A display system for a computer system, comprising:
a computer system having a plurality of electronic files stored therein,
a plurality of personalizable attributes assignable to each of said plurality of electronic files,
and a selection space capable of displaying the plurality of electronic files, wherein a user may arrange the electronic files within the selection space according to the personalizable attributes.

2. The display system of claim 1, wherein the selection space is a 3D representation.

3. The display system of claim 1, wherein the personalizable attributes are chosen from the group of attributes consisting of key words and classification information.

4. The display system of claim 1, wherein the selection space may be modified for viewing using a multiplicity of schemas.

5. The display system of claim 1, wherein the personalizable attributes are assigned manually by the user.

6. The display system of claim 1, wherein the personalizable attributes are assigned automatically based on classification controls or attribute database characteristics.

7. The display system of claim 6, wherein the personalizable attributes include XML metatags.

8. The display system of claim 1, wherein the selection space contains viewable images representative of the underlying file content.

9. The display system of claim 1, wherein the selection space has an appearance chosen from the group of schema consisting of a checkerboard, a bookstore, a music room, shelves, a virtual room and a cityscape.

10. The display system of claim 1, wherein the selection space has an appearance chosen from the group of schema consisting of hierarchical tree structures and cone trees.

11. The display system of claim 1, wherein a cursor of the computer system creates a visually magnified area of the selection space.

12. The display device of claim 1, wherein said computer system is selected from the group of computer systems consisting of game consoles, set-top boxes, personal computers, plant floor manufacturing equipment and automated control system.

13. The display device of claim 1, wherein said computer system is a mobile or wireless device.

14. A display system for a computer system, comprising:
a computer system having a plurality of electronic files stored therein, each of said plurality of electronic files having XML tags and an icon,
and a customizable 3D desktop containing the icons associated with said plurality of electronic files, the icons arranged based on information in the XML tags,
wherein a user may rearrange the icons.

15. The display device of claim 14, further comprising a plurality of user input fields and wherein said 3D desktop may be arranged based information contained in said plurality of user input fields.

16. The display device of claim 14, wherein said user input fields create XML tags.

17. A display system for a computer system, comprising:
a computer system having a plurality of electronic files stored therein,
a plurality of automatically generated WYSIWYG icons representing said plurality of electronic files, said WYSIWYG icons being generated based on file characteristics,
and a selection space capable of displaying the plurality of electronic files, wherein a user may arrange the electronic files within the selection space according to the personalizable attributes.

18. The display device of claim 17, wherein said file characteristics are selected from the group consisting of file size, date accessed, times accessed, and preferences.

19. The display device of claim 17, wherein said WYSIWYG icons have characteristics including size and color.

20. The display device of claim 17, wherein said WYSIWYG icon has a frequency of vibration.

21. The display device of claim 17, wherein said WLYSITYG icon has a sound.

22. The display device of claim 17, wherein said WYSIWYG icon is formed of multiple icons.

23. A method of storing, sorting and accessing files on a computer system, the method comprising the steps of:
(a) assigning a plurality of personalized attributes to an electronic file;
(b) and accessing a selection space having a user defined schema.

24. The method of claim 23, further comprising the step of scanning the electronic file to create a content-representative icon.

25. The method of claim 23, further comprising the step of modifying the icon within the selection space.

26. Method for applying and using XML information with a plurality of existing electronic files, the method comprising the steps of:
(a) opening an XML editor;
(b) determining a type of XML file information to be entered;
(c) entering XML tags for each electronic file;
(d) sorting the plurality of electronic files based on an application of rules or filters to the XML tags;
(e) and viewing the electronic files on a display.

27. The method of claim 26, wherein step (e) takes place in a 3D environment.

28. The method of claim 27, further comprising the steps of:
(f) rearranging the electronic files within the 3D environment to create a selected arrangement;
(g) and applying a reverse transformation to modify the XML tags, thereby allowing future application of rules or filters to result in the selected arrangement.

29. The method of claim 26, wherein the electronic files are selected from the types of files consisting of MP3 files, search engine results, file visualizations and bookmarks.

30. The method of claim 26, wherein step (e) has a visualization schema.

31. The method of claim 30, wherein the visualization schema is chosen from a group of schema consisting of a planetarium, a volumetric shape, a landscape, a hyperbola, a tree structure, a cityscapes, a grid array, a daterium.

32. The method of claim 30, wherein the editor adds auditory sonification.

33. The method of claim 32, wherein the editor automatically performs step (a) based on the use of fuzzy logic.

34. The method of claim 33, wherein the fuzzy logic determines the XML tag based on at least one user specified parameter.
